(19) United States
(12) Patent Application Publication
(10) Pub. No.: US 2025/0363251 A1
(43) Pub. Date: Nov. 27, 2025

(54) DISPLAY PRIVACY SYSTEM

(71) Applicant: GM Global Technology Operations LLC, Detroit, MI (US)

(72) Inventors: Manoj Kumar Sharma, Troy, MI (US); Donald K. Grimm, Utica, MI (US); Joseph F. Szczerba, Grand Blanc, MI (US)

(73) Assignee: GM Global Technology Operations LLC, Detroit, MI (US)

(21) Appl. No.: 18/671,026

(22) Filed: May 22, 2024

(51) Int. Cl. G06F 21/84; G06F 3/01; G06F 3/14

(52) U.S. Cl. CPC G06F 21/84; G06F 3/013; G06F 3/14

(57) ABSTRACT

A display privacy system for a vehicle includes an imager system including at least one tracking camera and a display configured to display content data. The display includes the at least one tracking camera. The display privacy system also includes a controller communicatively coupled with the imager system and the display. The controller includes data processing hardware that is configured to execute a display privacy application. The display privacy application includes an eye tracking function based on a gaze time and is configured to alter the content data in response to image data gathered by the imager system at the at least one tracking camera at the display.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a display privacy system. The display privacy system may be integrated as part of a vehicle. In other implementations, the display privacy system may be integrated as part of a device.

Traditional displays are capable of manual manipulation if the user desires to keep the content on the display private. For example, the user may reduce a brightness of the display, move the display away from nearby persons, or manually change the content. However, the displays are not configured to automatically protect privacy of the users based on content or based on surroundings. Further, displays equipped in shared spaces, such as vehicles, are typically visible to all occupants within the vehicle with minimal ability to adjust or alter the content on the display. Even when content can be changed on the shared display, the change is typically performed by the user rather than being automatically executed by the display. Thus, there is a need for improved privacy settings for display systems to improve privacy protection of content that is presented on displays.

### SUMMARY

In some aspects, a display privacy system for a vehicle includes an imager system including at least one tracking camera and a display configured to display content data. The display includes the at least one tracking camera. The display privacy system also includes a controller communicatively coupled with the imager system and the display. The controller includes data processing hardware that is configured to execute a display privacy application. The display privacy application includes an eye tracking function based on a gaze time and is configured to alter the content data in response to image data gathered by the imager system at the at least one tracking camera at the display.

In some examples, the display privacy application may include a proximity range and may be configured to alter the content data based on the proximity range and the gaze time of a detected gaze. Optionally, the display privacy application may include a display alteration protocol. The display alteration protocol may include one or more of an alert function, a dimming function, and a display change function. In some instances, the display change function may include an automatic display shift. The display alteration protocol may be configured to execute the automatic display shift in response to a gaze detected by the eye tracking function of the display privacy application.

In other examples, the data privacy application may include a privacy index. Optionally, the display may be a campfire display. In some instances, the display privacy application may include user profiles and may be configured to identify a user, based on the user profiles, via the imager system and the eye tracking function.

In other aspects, a computer-implemented method when executed by data processing hardware causes the data processing hardware to perform operations. The operations include executing, via the data processing hardware, an eye tracking function of a display privacy application, detecting, via the eye tracking function, a gaze at a display, and comparing, via the display privacy application, the detected gaze with one or more user profiles stored in memory hardware. The operations also include executing, via the data processing hardware, a display alteration protocol of the display privacy application in response to the detected gaze and altering, via the display alteration protocol, a content output of the display.

In some examples, executing the display privacy application may include alerting a user of the detected gaze and issuing a notification corresponding to audio privacy. Optionally, altering the content output may include issuing, via the display privacy application, a relocation recommendation. In some instances, altering the content output may include at least one of dimming the display, executing an alert function, and executing a display change function. In some configurations, executing the display change function may include changing content data of the content output and displaying an alternate output at the display. The operations may also include generating, via the display privacy application, a privacy index based on content data of the content output, the privacy index including a privacy score.

In further aspects, a system includes data processing hardware and memory hardware in communication with the data processing hardware. The memory hardware stores instructions that when executed on the data processing hardware cause the data processing hardware to perform operations. The operations include executing, via the data processing hardware, an eye tracking function of a display privacy application, detecting, via the eye tracking function, a gaze at a display, and comparing, via the display privacy application, the detected gaze with one or more user profiles stored in the memory hardware. The operations also include executing, via the data processing hardware, a display alteration protocol of the display privacy application in response to the detected gaze and altering, via the display alteration protocol, a content output of the display.

In some examples, executing the display privacy application may include alerting a user of the detected gaze. Optionally, altering the content output may include issuing, via the display privacy application, a relocation recommendation. In some configurations, altering the content output may include at least one of dimming the display, executing an alert function, and executing a display change function. In some instances, executing the display change function may include changing content data of the content output and displaying an alternate output at the display. The operations may also include generating, via the display privacy application, a privacy index based on content data of the content output, the privacy index including a privacy score.

### BRIEF DESCRIPTION OF THE DRAWINGS

The drawings described herein are for illustrative purposes only of selected configurations and are not intended to limit the scope of the present disclosure.

FIG. 1 is a schematic diagram of a display privacy system according to the present disclosure, the display privacy system including various displays;

FIG. 2 is an exemplary block diagram of a display privacy system according to the present disclosure;

FIG. 3 is another exemplary block diagram of a display privacy system according to the present disclosure;

FIG. 4 is a schematic diagram of an alert function of a display privacy application according to the present disclosure, the alert function including a notification;

FIG. 5 is a schematic diagram of another alert function of a display privacy application according to the present disclosure, the alert function including a flash function;

FIG. 6 is a schematic diagram of a dimming function of a display privacy application according to the present disclosure;

FIG. 7 is a schematic diagram of a display change function of a display privacy application according to the present disclosure;

FIG. 8 is another exemplary block diagram of a display privacy system according to the present disclosure; and

FIG. 9 is an exemplary flow diagram of a display privacy system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

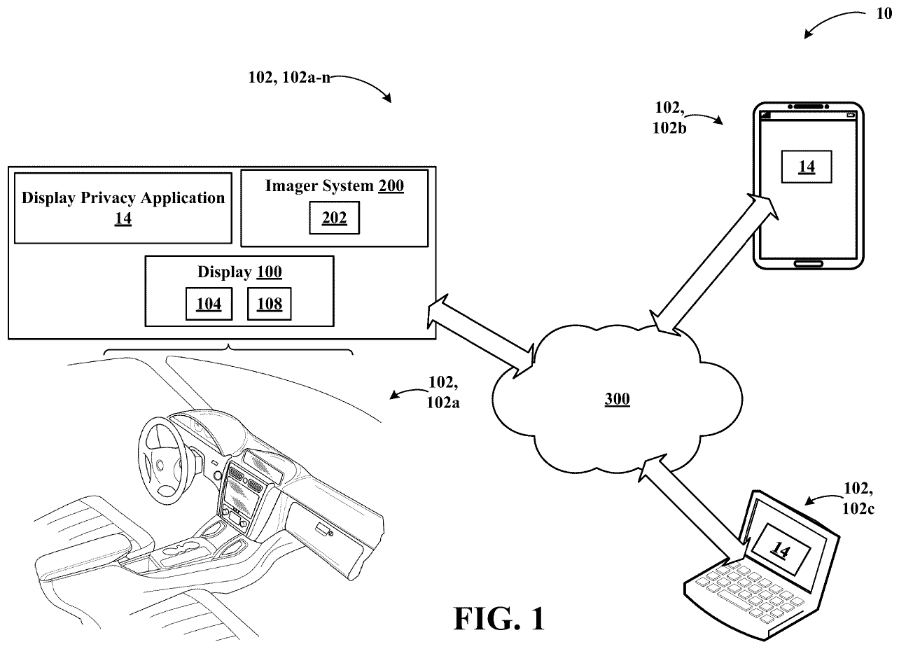

Referring to FIGS. 1-3, a display privacy system 10 includes a display 100 of a device 102, 102a-n, an imager system 200, and a cloud network 300 that may, in some examples, be utilized to execute computations of a display privacy application 12 executed by a controller 14 of the device 102, 102a-n. FIG. 1 illustrates various devices 102, 102a-n that may be equipped with the display privacy application 12 as part of the display privacy system 10. For example, the devices 102, 102a-n may include, but are not limited to, a vehicle 102a, a computer 102b, and a user device 102c. It is contemplated that the device 102, 102a-n may include other practicable devices 102, 102a-n that are equipped with a display 100 and an imager system 200. In some examples, the vehicle 102a may be equipped with a campfire display 100 in which the users may be positioned around the display 100. In this example, the users may view different content outputs 104, such that the display privacy system 10 may control or monitor the campfire display 100 and surrounding environment and execute the display privacy application 12 based on nearby users.

The imager system 200 includes at least one tracking camera 202 configured to capture image data 204. The tracking camera 202 may be integrated with the display 100, such that the tracking camera 202 may monitor a surrounding environment relative to the device 102, 102a-n when the device 102, 102a-n is in use by the user and communicate the surrounding environment with the display privacy application 12 as the image data 204. The image data 204 also includes a gaze 206 detected and captured by the tracking camera 202 and communicates the gaze 206 with the display privacy application 12. The environment captured by the tracking camera 202 may include an area where a third-party may view the display 100 of the device 102, 102a-n when the user may otherwise desire to keep a content output 104 of the display 100 private, as described in more detail below.

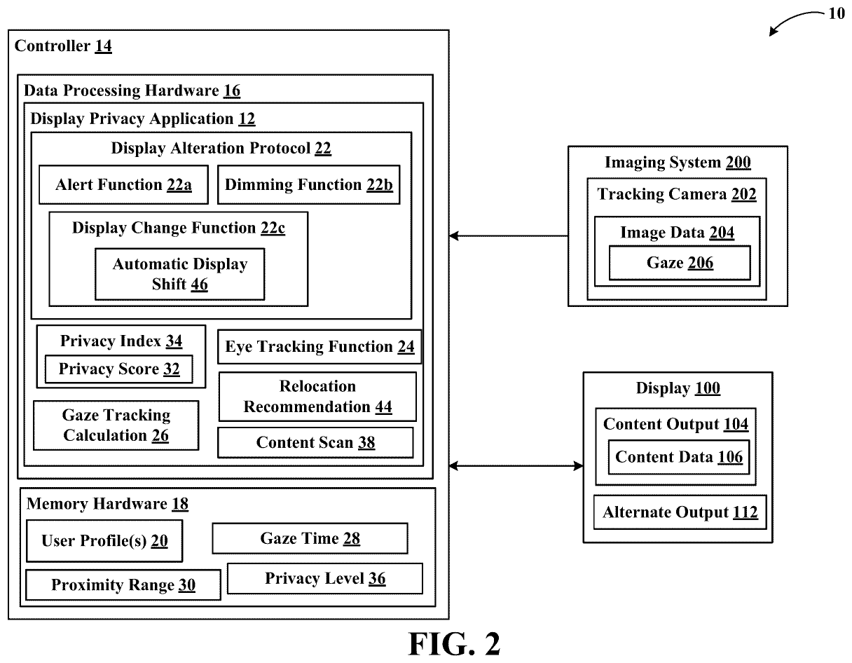

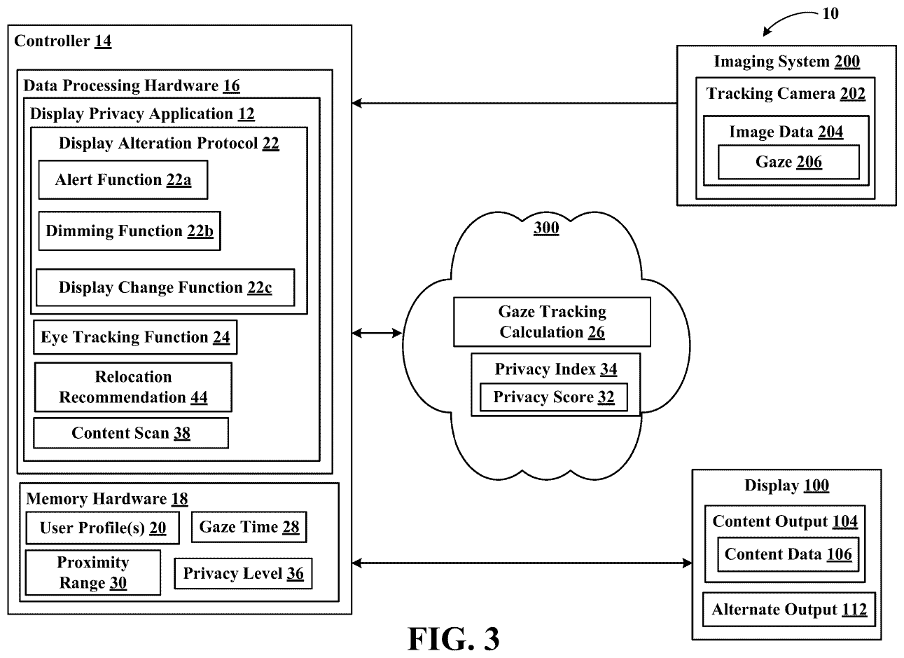

FIG. 2 illustrates an exemplary block diagram of the display privacy system 10 in which the display privacy application 12 is configured on data processing hardware 16 of the controller 14 of the device. In the example illustrated in FIG. 2, and as described herein, the controller 14 is configured to execute computations for the display privacy application 12. FIG. 3 illustrates another exemplary block diagram of the display privacy system 10 in which the computations for the display privacy application 12 are executed by the cloud network 300 and communicated with the controller 14 of the device 102, 102a-n to execute the display privacy application 12, as described herein. In either implementation, the controller 14 is configured with the display privacy application 12, with the difference between implementations being the execution of the computational processes described herein associated with the display privacy application 12. For purposes of explanation, the display privacy application 12 is described as being computed and executed by the controller 14, but the computation processes associated with the display privacy application 12 may be executed by either the controller 14 or the cloud network 300.

With continued reference to FIGS. 1-3, the display privacy application 12 is a computer vision algorithm that is executed by the data processing hardware 16 of the controller 14 of the device 102, 102a-n. The controller 14 also includes memory hardware 18 that stores one or more user profiles 20 associated with the display privacy application 12. The memory hardware 18 is in communication with the data processing hardware 16 and stores instructions that, when executed on the data processing hardware 16, cause the data processing hardware 16 to perform operations described herein. The controller 14 is communicatively coupled with the display 100 and the imaging system 200, such that content data 106 from the display 100 and image data 204 from the imager system 200 are communicated with the display privacy application 12.

The display privacy application 12 is configured to execute a display alteration protocol 22 based on an eye tracking function 24 of the display privacy application 12. The display privacy application 12 is communicatively coupled to the imager system 200, such that the eye tracking function 24 of the display privacy application 12 is executed by the tracking camera 202. The eye tracking function 24 is configured to detect and capture the gaze 206 of persons in a surrounding environment relative to the display 100. In some examples, the eye tracking function 24 is based on a gaze time 28, such that the gaze 206 is captured when the gaze 206 meets or exceeds the gaze time 28, described below. The imager system 200 communicates the detected and captured gaze 206 with the display privacy application 12. In response, the display privacy application 12 executes a gaze tracking calculation 26. The gaze tracking calculation 26 utilizes a gaze time 28 that may be stored in the memory hardware 18 to compare the gaze 206 to a predetermined period of time (i.e., the gaze time 28) that is configured to trigger the display alteration protocol 22. For example, if the gaze 206 corresponds to the predetermined gaze time 28 with the person within a proximity range 30, then the gaze tracking calculation 26 may result in triggering the display alteration protocol 22, described below.

The proximity range 30 may be utilized to determine a proximity of a person that is associated with the captured gaze 206. The proximity range 30 may be predefined and stored on the memory hardware 18. For example, the proximity range 30 may be a radial distance from the display 100 at which a person may focus on the display 100 in order to identify the content output 104 on the display 100. Thus, the display privacy application 12 is more likely to detect and capture the gaze 206, via the imaging system 200, when the person is within the proximity range 30. The image data 204 communicated to the display privacy application 12 may also include facial recognition data, such that the display privacy application 12 may compare the image data 204 with the user profiles 20 stored on the memory hardware 18. For example, the detected gaze 206 may be that of the user, such that the display privacy application 12 would identify the user and continue monitoring the image data 204 for another gaze 206 without activating the display alteration protocol 22.

The user profiles 20 may be registered users of the device 102, 102a-n including identifiable biometric data, such as facial images and scans uploaded to the respective user profiles 20. The controller 14 may be configured to store multiple user profiles 20, such that the display privacy application 12 may compare the image data 204 with each user profile 20 to confirm whether the gaze 206 is associated with an authorized user (i.e., a user with a stored user profile 20). In some instances, the display privacy application 12 may adapt to include known users based on the image data 204 over a period of time. For example, a user may frequently use the display 100 with a non-registered user (i.e., a user without a stored user profile 20), and the display privacy application 12 may update the user profiles 20 to include a known person based on the periodically captured and analyzed image data 204. The display privacy application 12 is configured to identify a user, based on the user profile(s) 20, via the imager system 200 and the eye tracking function 24.

With reference to FIGS. 2-6, the display privacy application 12 utilizes the gaze 206 and the image data 204 to determine a level of execution of the display alteration protocol 22, described below. The display privacy application 12 determines a privacy score 32 based on a privacy index 34, which may be utilized, at least in part, to identify an execution of the display alteration protocol 22. The privacy index 34 may be defined as a scale that is used to measure a degree of privacy of the environment surrounding the display 100 and the respective user. The degree of privacy is reflected by the privacy score 32 generated by the display privacy application 12. In addition to the image data 204 (i.e., the surrounding environment), the display privacy application 12 analyzes the content data 106 from the display 100 corresponding to the content output 104 at the display 100.

The content data 106 is utilized by the display privacy application 12 to identify whether the content output 104 is classified as confidential content. The content output 104 may have a privacy level 36 that may be stored in the memory hardware 18 as part of the display privacy application 12. In this example, the content data 106 may be known by the controller 14, such that the content may be stored on the device 102, 102a-n and have a known privacy level 36. In other examples, the display privacy application 12 may execute a content scan 38 of the content data 106 to identify any privacy language or other document markings in the content data 106 that may trigger the execution of the display alteration protocol 22. For example, the user may open a document (i.e., content output 104) on the display 100 that has language indicating that the document is classified or otherwise confidential. Thus, the display privacy application 12 may use any content data 106 received or gathered from the display 100 to execute the display alteration protocol 22. In some instances, the privacy level 36, whether determined or identified, may be utilized in identifying which function 22a-22c of the display alteration protocol 22 to execute.

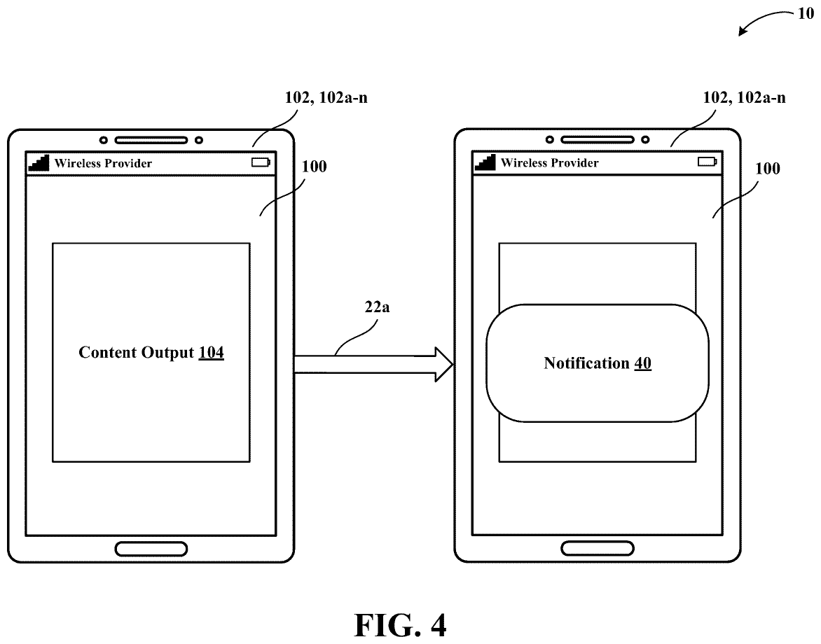

The privacy level 36 may be used in combination with the privacy score 32, based on the privacy index 34 and determined by the gaze tracking calculation 26, to determine the function 22a-22c execution of the display alteration protocol 22. The display alteration protocol 22 may be triggered in response to the gaze tracking calculation 26, as mentioned above, and may execute various functions 22a-22c. For example, the display alteration protocol 22 may include, but is not limited to, an alert function 22a, a dimming function 22b, and a display change function 22c. The functions 22a-22c of the display alteration protocol 22 may be determined based on the gaze tracking calculation 26 and the content data 106 and are described with respect to FIGS. 4-6.

In some examples, the privacy score 32 may be a lower score indicating that the privacy surrounding the display 100 is moderate to high meaning there may be few detected gazes 206. However, the display privacy application 12 may still detect a gaze 206 and execute the alert function 22a of the display alteration protocol 22. For example, the alert function 22a is illustrated in FIG. 4 as issuing a notification 40 blocking the content output 104. The user may dismiss the notification 40 or may take action to change the content output 104 in response to the notification 40. In some instances, the notification 40 may include an option for the display alteration protocol 22 to automatically change the content output 104 based on a confirmation from the user.

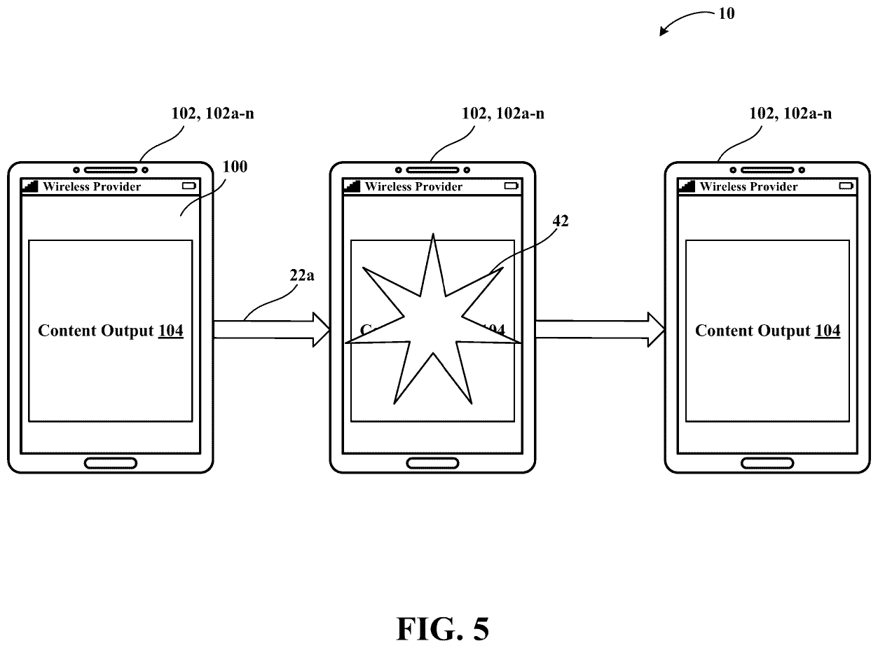

The alert function 22a may also include, in some examples, a flash function 42, illustrated in FIG. 5. For example, the display privacy application 12 identifies the gaze 206 and determines that the gaze 206 satisfies the gaze time 28. In response, the display alteration protocol 22 may execute the flash function 42 of the alert function 22a, which flashes the display 100 to alert the user of the gaze 206. The flash function 42 may be executed a predetermined number of times after execution or may be a singular flash across the display 100. The flash function 42 is configured to be sufficient enough to garner the attention of the user to encourage the user to take action to protect or improve the privacy of the display 100. Further, the duration of the flash function 42 and/or frequency of the flash function 42 may be customized by the user in the user profile 20.

In some examples, the notification 40 may include an alert that privacy of the display 100 may be compromised and a recommendation to wait to open potential confidential materials and/or personal materials. Further, the notification 40 may indicate to the user that a third party is looking at the display 100 via the gaze 206. In other examples, the notification 40 may indicate that a third party is within a vicinity of the user that may result in the third party overhearing the user's audio or conversation. Thus, the notification 40 may be configured for audio privacy. The alert function 22a may also issue a relocation recommendation 44. The relocation recommendation 44 may include a location within the surrounding environment that has been identified by the display privacy application 12, via the image data 204, as having increased levels of privacy as compared to a current location of the user. For example, the display privacy application 12 may identify that the user may have increased levels of privacy by relocating to a location to the right or left of the user and/or relocating to a more private location. The relocation recommendation 44 may be based on the image data 204 as well as the content data 106 of the content output 104 on the display 100.

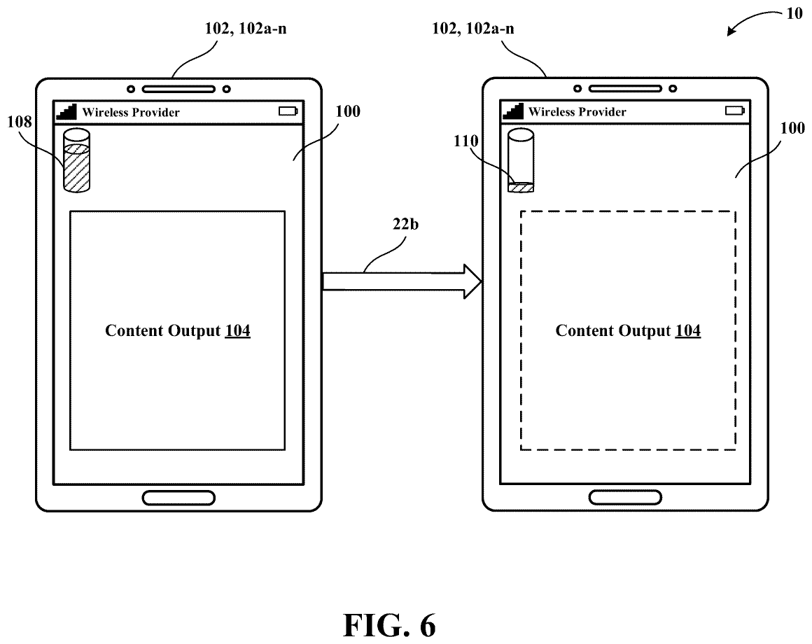

The display alteration protocol 22 may also execute a dimming function 22b in response to a moderate to high privacy score 32. The dimming function 22b, illustrated in FIG. 6, illustrates an automatic shift in a brightness 108 of the display 100. For example, the moderate to high privacy score 32 may be determined by the detected gaze 206 meeting or exceeding the predetermined gaze time 28 with the person(s) within the proximity range 30. In addition, the privacy score 32 may be escalated based on the content data 106 of the content output 104. The dimming function 22b may have a preset dim level 110, illustrated by the content output 104 in FIG. 6 being in dashed lines, that alters the brightness 108 of the display from a current brightness 108 to the preset dim level 110. The dimming function 22b may also utilize the image data 204 to alter the brightness 108 based on an environment brightness detected by the imager system 200. For example, in some instances, the dimming function 22b may reduce the brightness 108 by a lesser degree compared to other instances depending on the environment brightness.

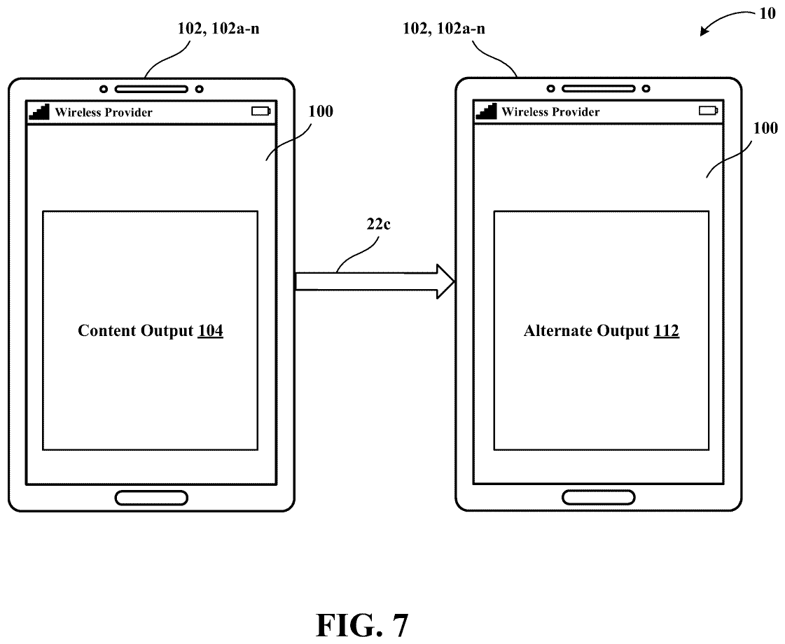

In other examples, the privacy score 32 may be determined to be high and corresponding to highly classified or confidential content. The display alteration protocol 22 may execute, in response to the high privacy score 32, the display change function 22c. The display change function 22c may include, but is not limited to, turning off the display 100, removing or hiding the content output 104, and changing the content output 104 to an alternate output 112. For example, the display privacy application 12 may determine, based on the content data 106, that the content output 104 contains confidential materials and, in response, may execute an automatic display shift 46 of the display change function 22c. FIG. 7 illustrates one exemplary execution of the automatic display shift 46 where the content output 104 is removed from the display 100 and replaced with an alternate output 112. The automatic display shift 46 is triggered by the determination of a high privacy score 32 relative to the content data 106. Thus, the display privacy application 12 is configured to maximize the privacy protection when the content data 106 correlates to a high privacy score 32.

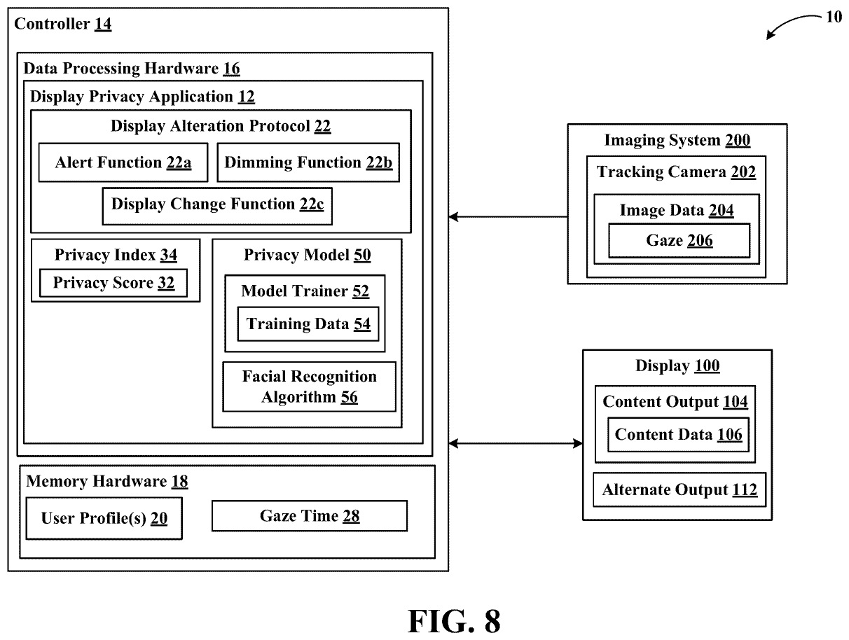

Referring still to FIGS. 2-8, the display alteration protocol 22 may be configured by the user, such that the user may select which functions 22a-22c to execute based on the privacy score and index 32, 34. In other examples, the display alteration protocol 22 may be configured as a multi-mode where each of the functions 22a-22c correspond to a progressive level based on the privacy index 34, as generally referenced above. For example, a first level corresponding to a low privacy score 32 may have the display alteration protocol 22 execute the notification 40 or flash function 42 of the alert function 22a, at a second level, execute the dimming function 22b, and at a third level, corresponding to a high privacy score 32, the display alteration protocol 22 may turn-off the display 100 via the display change function 22c.

With respect to FIGS. 2, 3, and 8, it is contemplated that the user may customize the functions 22a-22c of the display alteration protocol 22 to execute based on a customized privacy index 34. For example, the user may determine that any identified gaze 206 within the gaze time 28 may result in the execution of the display change function 22c. In further examples, the user may customize the settings of the display alteration protocol 22 to execute any one of the functions 22a-22c in a variety of orders and combinations to advantageously alert the user as to the gaze 206 and protect the privacy of the content output 104 on the display 100.

As noted above, the display privacy application 12 may be configured to identify a pair of users that are traveling together and/or frequently travel together and may thus maintain the content output 104 on the display 100 when both users are recognized by the display privacy application 12. Where there are multiple users, the privacy score 32 may be lowered to accommodate more users looking at the display 100 and thus have less privacy restrictions. Thus, when users are treated as a pair or group, then the display privacy application 12 may identify multiple users and identify the users as a single group with a connected relationship.

In some examples, the display privacy application 12 may be also include a privacy model 50. The privacy model 50 may be configured with a model trainer 52 to obtain training data 54 for training the privacy model 50. The privacy model 50 may be configured as a machine learning model, such that the model trainer 52 is configured to train the privacy model 50 based on the training data 54. The model trainer 52 may retrieve the training data 54 from, for example, the image data 204, such that the training data 54 includes, but is not limited to, the gaze 206. The training data 54 may also include any other type of data that the privacy model 50 is trained to receive (e.g., environmental data). The privacy model 50 is trained to identify a user and recognize an associated gaze 206 of a known user.

For example, the image data 204 may include images from the imager system 200 configured to capture biometric data, mentioned above, in addition to environmental data. The privacy model 50 processes the image data 204 through a face detection algorithm 56 trained by the model trainer 52 based on the training data 54. The privacy model 50 compares features of faces captured as part of the image data 204 and identifies a match. Once identified, the display privacy application 12 may open a personalized display 100. If the face detection algorithm 56 does not identify a match, then the display privacy application 12 may recommend the user register a user profile 20.

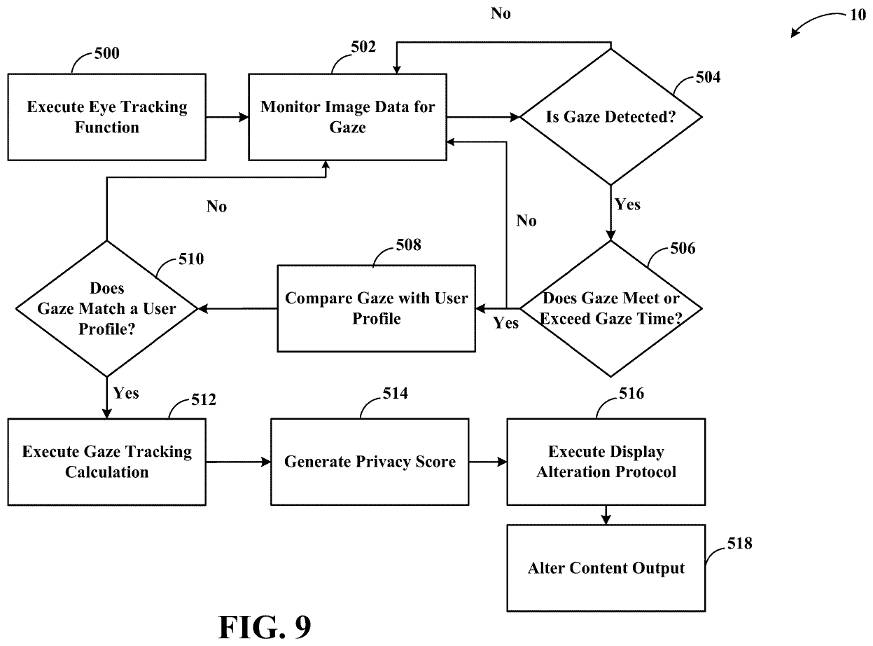

FIG. 9 illustrates an exemplary flow diagram of the display privacy system 10. At 500, the display privacy system 10 executes the eye tracking function 24 of the display privacy application 12 and monitors, at 502, the image data 204 for a gaze 206. The display privacy system 10 determines, at 504, whether a gaze 206 is detected. If no gaze 206 is detected, then the display privacy system 10 continues to monitor for a gaze 206. If a gaze 206 is detected, then the display privacy system 10 determines, at 506, whether the gaze 206 meets or exceeds the gaze time 28. If not, then the display privacy system 10 again continues to monitor the image data for a gaze 206.

If a gaze 206 is detected and meets or exceeds the gaze time 28, then the display privacy system 10 compares, at 508, the gaze 206 with the user profile(s) 20. The display privacy system 10 then determines, at 510, whether the gaze 206 matches a user profile 20. If the gaze 206 does match a user profile 20, then the display privacy system 10 returns to monitoring the image data 204. If the gaze 206 does not match a user profile 20, then the display privacy system 10 executes, at 512, the gaze tracking calculation 26 and generates, at 514, a privacy score 32. The display privacy system 10 may then execute, at 516, the display alteration protocol 22 based on the privacy score 32 and alter, at 518, the content output 104.

Referring again to FIGS. 1-9, the display privacy system 10 advantageously assists users in maintaining privacy of a display 100 on a respective device 102, 102a-n. The display privacy system 10 may be configured to automatically adjust or alter the content output 104 of the display 100 to maximize privacy and notify the user of potential gazes 206. The execution of the display alteration protocol 22 of the display privacy application 12 assists the user in securing confidential or sensitive content from being viewed by unauthorized viewers. Further, the gaze tracking calculations 26 and determination of potential relocation may be offloaded to a cloud network 300, such that the computational power of the respective device 102, 102a-n may be maintained.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A display privacy system for a vehicle, the display privacy system comprising:
an imager system including at least one tracking camera;
a display configured to display content data and including the at least one tracking camera; and
a controller communicatively coupled with the imager system and the display, the controller including data processing hardware configured to execute a display privacy application, the display privacy application including an eye tracking function based on a gaze time and being configured to alter the content data in response to image data gathered by the imager system at the at least one tracking camera at the display.

2. The display privacy system of claim 1, wherein the display privacy application includes a proximity range and is configured to alter the content data based on the proximity range and the gaze time of a detected gaze.

3. The display privacy system of claim 1, wherein the display privacy application includes a display alteration protocol.

4. The display privacy system of claim 3, wherein the display alteration protocol includes one or more of an alert function, a dimming function, and a display change function.

5. The display privacy system of claim 4, wherein the display change function includes an automatic display shift, the display alteration protocol being configured to execute the automatic display shift in response to a gaze detected by the eye tracking function of the display privacy application.

6. The display privacy system of claim 1, wherein the display privacy application includes a privacy index.

7. The display privacy system of claim 1, wherein the display is a campfire display.

8. The display privacy system of claim 1, wherein the display privacy application includes user profiles and is configured to identify a user, based on the user profiles, via the imager system and the eye tracking function.

9. A computer-implemented method when executed by data processing hardware causes the data processing hardware to perform operations comprising:
executing, via the data processing hardware, an eye tracking function of a display privacy application;
detecting, via the eye tracking function, a gaze at a display;
comparing, via the display privacy application, the detected gaze with one or more user profiles stored in memory hardware;
executing, via the data processing hardware, a display alteration protocol of the display privacy application in response to the detected gaze; and
altering, via the display alteration protocol, a content output of the display.

10. The method of claim 9, wherein executing the display privacy application includes alerting a user of the detected gaze.

11. The method of claim 10, wherein altering the content output includes issuing, via the display privacy application, a relocation recommendation.

12. The method of claim 9, wherein altering the content output includes at least one of dimming the display, executing an alert function, and executing a display change function.

13. The method of claim 12, wherein executing the display change function includes changing content data of the content output and displaying an alternate output at the display.

14. The method of claim 9, further including generating, via the display privacy application, a privacy index based on content data of the content output, the privacy index including a privacy score.

15. A display privacy system comprising:
data processing hardware; and
memory hardware in communication with the data processing hardware, the memory hardware storing instructions that when executed on the data processing hardware cause the data processing hardware to perform operations, the operations comprising:
executing, via the data processing hardware, an eye tracking function of a display privacy application stored in the memory hardware;
detecting, via the eye tracking function, a gaze at a display;
comparing, via the display privacy application, the detected gaze with one or more user profiles stored in the memory hardware;
executing, via the data processing hardware, a display alteration protocol of the display privacy application in response to the detected gaze; and
altering, via the display alteration protocol, a content output of the display.

16. The display privacy system of claim 15, wherein executing the display privacy application includes alerting a user of the detected gaze and issuing a notification corresponding to audio privacy.

17. The display privacy system of claim 16, wherein altering the content output includes issuing, via the display privacy application, a relocation recommendation.

18. The display privacy system of claim 15, wherein altering the content output includes at least one of dimming the display, executing an alert function, and executing a display change function.

19. The display privacy system of claim 18, wherein executing the display change function includes changing content data of the content output and displaying an alternate output at the display.

20. The display privacy system of claim 15, further including generating, via the display privacy application, a privacy index based on content data of the content output, the privacy index including a privacy score.
